(19) United States
(12) Patent Application Publication
(10) Pub. No.: US 2025/0021326 A1
(43) Pub. Date: Jan. 16, 2025

(54) CSS LIBRARY ISOLATION

(71) Applicant: VMware LLC, Palo Alto, CA (US)

(72) Inventor: Nikola Vladimirov Iliev, Sofia (BG)

(73) Assignee: VMware LLC, Palo Alto, CA (US)

(21) Appl. No.: 18/221,705

(22) Filed: Jul. 13, 2023

(51) Int. Cl. G06F 8/658

(52) U.S. Cl. CPC G06F 8/658

(57) ABSTRACT

Cascading style sheets (CSS) library isolation can include replacing instances of a definition of a base root element font size from CSS code of a user interface (UI) plugin to a hosting application with a CSS variable as the CSS code is compiled to a CSS file, reading a definition of a quantity of pixels per one root element font size from the UI plugin, calculating a ratio between the base root element font size of the UI plugin and a base root element font size of the hosting application in pixels, and defining the CSS variable as the ratio at runtime.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

A cloud services platform can deliver secure, isolated, and elastic virtual data center compute, network, storage, and security in a self-service model. The cloud services platform can be used to partition and manage first party cloud services on third party resource pools and made available to tenants through an on-demand self-service model in a securely isolated multitenant environment. The cloud services platform can be used to build secure multitenant clouds by pooling virtual infrastructure resources into virtual data centers. The clouds can be exposed to tenants by using web-based portals and programmatic interfaces as a fully automated catalog-based service. A user can interact with the cloud services platform via a cloud services platform user interface (UI).

### BRIEF DESCRIPTION OF THE DRAWINGS

FIG. 1 is a diagram of a system for CSS library isolation.

FIG. 2 is a compile time method flow diagram for CSS library isolation.

FIG. 3 is a runtime method flow diagram for CSS library isolation.

FIG. 4 is a method flow diagram for CSS library isolation.

### DETAILED DESCRIPTION

A cloud services platform can incorporate user interface (UI) plugins. Once written, it would be desirable for the UI plugins to remain working for multiple versions of the cloud services platform. The multiple versions of the cloud services platform may be released over many years, which is a long time with respect to the UI plugins.

The UI plugins that operate within the cloud services platform UI may borrow cascading style sheets (CSS) libraries (e.g., dependencies) at runtime to reduce the file size of the UI plugin itself. The UI plugins can reuse CSS libraries provided by the cloud services platform. CSS is a style sheet language used for describing the presentation of a document written in a markup language, such as hypertext markup language (HTML) or extensible markup language (XML). CSS enables the separation of content and presentation, including layout, colors, and fonts. The separation can improve content accessibility, provide more flexibility and control in the specification of presentation characteristics, enable multiple web pages to share formatting by specifying the relevant CSS in a separate CSS file, which reduces complexity and repetition in the structural content, and enable the CSS file to be cached to improve the page load speed between the pages that share the file and its formatting.

However, when the cloud services platform switches to a new version of a CSS framework that is shared with the UI plugins, the UI plugins face a risk of appearing to have a broken visualization or not working at all. A CSS framework can encompass a CSS library and allow for easier, more standards-compliant web design using the CSS language. The CSS framework may include a grid (a structure made up of a series of intersecting lines used to structure content). The CSS framework may also include features such as JavaScript based functions. The CSS framework can be design oriented and focused around interactive UI patterns. A CSS library is a set of instructions that provides specific operations within the CSS domain. Some previous approaches do not permit multiple versions of a CSS framework to run simultaneously in a browser.

Each CSS framework defines its own root element font size, which is the size with which a web page scales. The root element font size is used for widths, heights, paddings, font sizes, etc. Typically, only one root element font size (rem) is defined. For example, 1 rem=16 pixels. Once defined, the root element font size cannot be changed. However, two different versions of a CSS framework may include different root element font sizes. For example, version 1 (1 rem=16 pixels); version 2 (1 rem=24 pixels). If both versions of the CSS framework are used together in a web page, either the first or the second will shrink or grow compared to the expected/intended result because the other version set the root element font size to be larger or smaller than expected/intended.

One or more embodiments of the present disclosure address the above and other deficiencies to enable a cloud services platform UI to support multiple versions of a CSS framework to run simultaneously in a browser without conflicting root element font sizes or spacing side effects from the multiple versions of the CSS framework.

The figures herein follow a numbering convention in which the first digit or digits correspond to the drawing figure number and the remaining digits identify an element or component in the drawing. Similar elements or components between different figures may be identified by the use of similar digits. A group or plurality of similar elements or components may generally be referred to herein with a single element number. For example, a plurality of reference elements 124-1, 124-2 may be referred to generally as 124. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

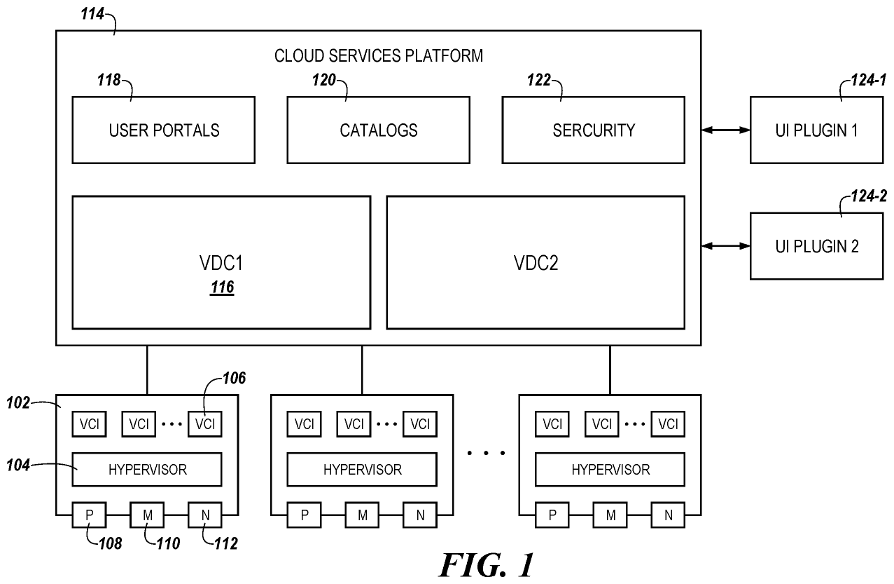

FIG. 1 is a diagram of a system for CSS library isolation. The system can include a number of hosts 102. The hosts 102 can be provisioned with processing resource(s) 108 (e.g., one or more processors), memory resource(s) 110 (e.g., one or more main memory devices and/or storage memory devices), and/or a network interface 112. The hosts 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

Memory resources 110 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media. The memory resources 110 can be machine readable media that can store program instructions (e.g., machine-readable instructions) to implement a particular function (e.g., an action such as providing CSS library isolation, as described herein). The set of instructions can be executable by one or more of the processing resources 108.

The processing resources 108 can be coupled to the memory resources 110 via a communication path. The communication path can be local or remote to the host 102. Examples of a local communication path can include an electronic bus internal to a machine, where the memory resources 110 are in communication with the processing resources 108 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path can be such that the memory resources 110 are remote from the processing resources 108, such as in a network connection between the memory resources 110 and the processing resources 108. That is, the communication path can be a network connection. Examples of such a network connection can include a local area network (LAN), wide area network (WAN), personal area network (PAN), and the Internet, among others.

The hosts 102 can incorporate respective hypervisors 104 that can execute a number of virtual computing instances VCIs 106. The VCIs can be provisioned with processing resources 108 and/or memory resources 110 and can communicate via the network interface 112. The processing resources 108 and the memory resources 110 provisioned to the VCIs 106 can be local and/or remote to the hosts 102 (e.g., the VCIs 106 can be ultimately executed by hardware that may not be physically tied to the VCIs 106). For example, in a software defined data center, the VCIs 106 can be provisioned with resources that are generally available to the software defined data center and are not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106.

The hosts 102 can be coupled to a cloud services platform 114. The cloud services platform 114 can pool and allocate the resources provided by the hosts 102 among different customers, departments, and/or virtual data centers (VDCs) 116. VDCs 116 allow service providers to simplify, reorganize, and group hosts 102 in a multitenant fashion. VDCs 116 can be split into various organizations, which can further be split into groups and managed with permissions. For example, a particular company can be assigned its own VDC 116 where it can provision virtualized applications, VCIs 106, and virtual storage. Virtual networks can be set up with routers, switches, and firewalls.

The cloud services platform 114 can provide user portals 118 that can be used by organization administrators to manage the organization's use of the VDCs 116, VCIs 106, virtualized applications, networks, etc. The user portals 118 can allow use of catalogs 120, virtualized application and/or VDC 116 templates, and cross-VDC networks, among other functionality. The cloud services platform 114 can allow administrators and catalog authors to create catalogs 120 for their organization. The catalogs 120 can store virtualized application templates and media files. The catalogs 120 can be shared with other users within the organization and/or published externally. The catalogs 120 can be made private, shared, or externally available. The cloud services platform 114 can provide a broad range of security 122, such as malware prevention, firewalls, dynamic group and membership criteria, encrypted workloads, intrusion detection, intrusion prevention, centralized data collection and analytics, disaster recovery, etc.

A user portal 118 can be accessed via a UI plugin 124. According to at least one embodiment, the cloud services platform 114 can support multiple versions of UI plugins, such as a first UI plugin 124-1 and a second UI plugin 124-2. The UI plugins 124 can be configured to allow users to access information and/or services provided by the cloud services platform 114. The user can be presented with a welcome page in a UI of the cloud services platform 114, or via a separate browser. Either option can be used to access features of the cloud services platform 114 that are available to the user.

The cloud services platform 114 can replace instances of a first definition of a base root element font size from code of a first version of a UI plugin 124-1 to the cloud services platform 114 with a first CSS variable as the code of the first version of the UI plugin is compiled. The cloud services platform 114 can replace instances of a second definition of a base root element font size from code of a second version of a UI plugin 124-2 to the cloud services platform 114 with a second CSS variable as the code of the second version of the UI plugin is compiled. The cloud services platform 114 can read a first definition of a first quantity of pixels per one root element font size from the first version of the UI plugin 124-1 and read a second definition of a second quantity of pixels per one root element font size from the second version of the UI plugin 124-2. The cloud services platform 114 can calculate a first ratio between the base root element font size of the first version of the UI plugin 124-1 and a base root element font size of the hosting application in pixels and calculate a second ratio between the base root element font size of the second version of the UI plugin 124-2 and a base root element font size of the hosting application in pixels. The cloud services platform 114 can define the first CSS variable as the first ratio and define the second CSS variable as the second ratio at runtime of the cloud services platform 114. The cloud services platform can perform the above tasks analogously for a third, fourth, or any additional number of versions of the UI plugins. As a result, and as described in more detail below, a webpage can be presented to a first user of the first UI plugin 124-1 without spacing side effects and the webpage can be presented to a second user of the second UI plugin 124-2 without spacing side effects. In some examples, the first version of the UI plugin 124-1 was developed for a previous version of the cloud services platform 114 that included a different CSS library than a current version of the cloud services platform 114.

As referred to herein, VCI covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization that can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

VCIs have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

Multiple VCIs can be configured to be in communication with each other in an SDDC. In such a system, information can be propagated from a client (e.g., an end user) to at least one of the VCIs in the system, between VCIs in the system, and/or between at least one of the VCIs in the system and a server. SDDCs are dynamic in nature. For example, VCIs and/or various application services, may be created, used, moved, or destroyed within the SDDC. When VCIs are created, various processes and/or services start running and consuming resources. As used herein, “resources” are physical or virtual components that have a finite availability within a computer or SDDC. For example, resources include processing resources, memory resources, electrical power, and/or input/output resources.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

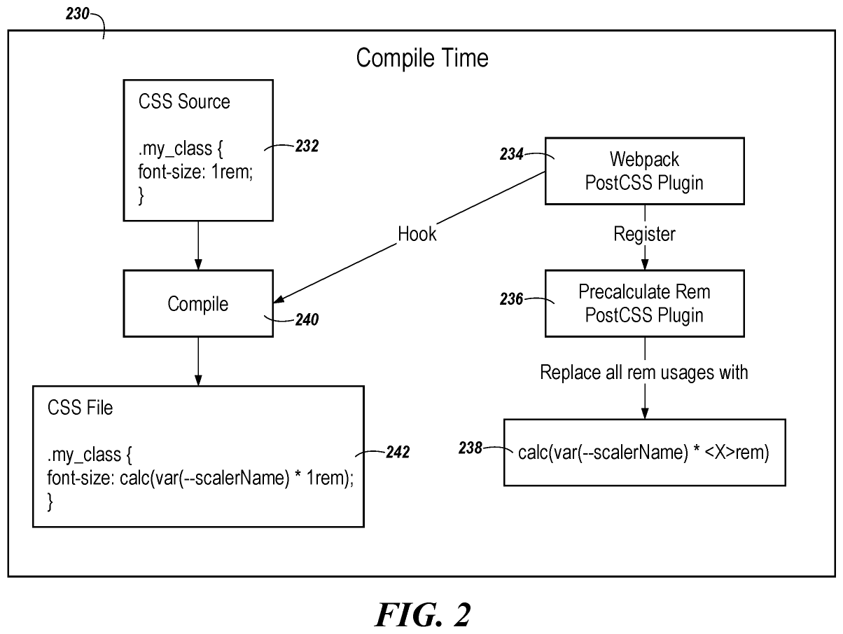

FIG. 2 is a compile time 230 method flow diagram for CSS library isolation. CSS source code 232 of any UI plugin (e.g., UI plugin 124-1 illustrated in FIG. 1) can be preprocessed 236 in compile time. The build process of the UI plugin can be hooked using a plugin as illustrated at 234 (e.g., Webpack PostCSS Plugin). Instances of a respective definition of a base root element font size in CSS source code 232 of each UI plugin can be replaced with a respective CSS variable 238 as the CSS code 232 is compiled 240 to a CSS file 242. As illustrated at 232, in this example, the base root element font size defined in the CSS source code 232 is 1 rem (e.g., as opposed to 1.2 rem, 1.5 rem, etc.). The CSS variable 238 can be a scalar variable (e.g., scalerName) to scale the root element font sizes by making them dynamic. A value of the CSS variable 238 can be defined at runtime.

As illustrated at 232, 238, and 242 the rem usage from the CSS source code 232 “font-size: 1 rem;” is replaced with “calc(var(—scalerName)*<X>rem)” such that the CSS file 242, after being compiled, includes “font-size: calc(var(—scalerName)*1rem);”. Note that the definition of the base root element font size from the CSS code 232 remains in the CSS file 242 (i.e., “1rem”). If the base root element font size had been, for example, 1.5 rem, the value would have read “1.5rem”. The base root element font size will be scaled by a calculation (in runtime) after the value of the scalar variable 238 is defined.

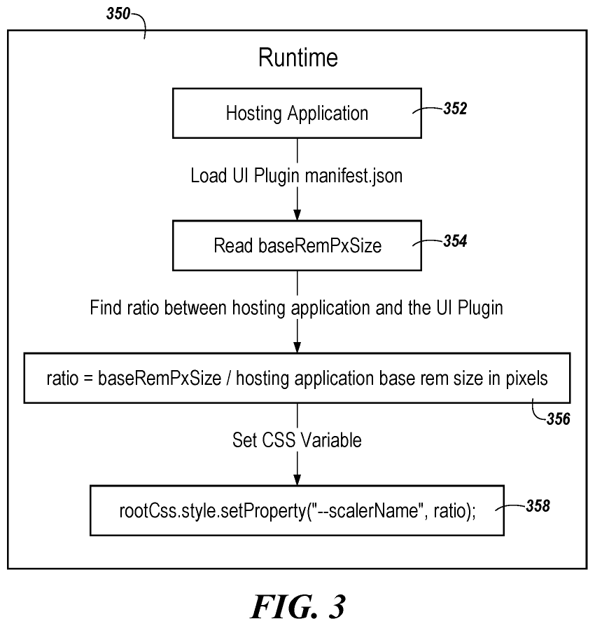

FIG. 3 is a runtime 350 method flow diagram for CSS library isolation. The runtime 350 method flow diagram essentially picks up where the compile time 230 flow diagram illustrated in FIG. 2 left off. The runtime can be the runtime of the hosting application 352. The example of the hosting application 352 used herein is a cloud services platform UI, however embodiments are not so limited. A UI plugin can include a definition of a quantity of pixels per one root element font size (rem=1) for the UI plugin even if the base root element font size is something other than 1 (e.g., 1.2, 1.5, etc.). The definition of the quantity of pixels per 1 rem may be different for different versions of the UI plugin and may be different for the hosting application (e.g., cloud services provider UI). That definition may be stored in the manifest.json file and the definition itself may be referred to as “baseRemPxSize”. Therefore, instructions can be executed to read 354 a respective definition of a respective quantity of pixels per one root element font size from each UI plugin at runtime 350.

With this information, a ratio between the respective base root element font size of each UI plugin and a base root element font size of the cloud services platform UI can be calculated 356 in terms of pixels. The calculation 356 can occur in runtime 350 of the cloud services platform UI and therefore, the base root element font size of the cloud services platform UI can be known, thus enabling the calculation 356. Alternatively, the value of the base root element font size of the hosting application could be known to the coder. As illustrated at 356, the ratio is “baseRemPxSize/hosting application base rem size in pixels”.

With this calculation, the respective CSS variable can be defined 358 as the respective ratio at runtime 350. As illustrated at 358, the definition of the CSS variable can be “rootCSS.style.setProperty(”—scalerName“, ratio);”.

Referring back to FIG. 2, this would replace “var(—scalerName)” in the CSS file 242 with the ratio. The result is that the ratio is multiplied by the base root element font size of the UI plugin in the CSS file 242. This allows for a common visualization to be presented via each UI plugin regardless of the respective definition of the base root element font size from CSS files of each UI plugin. Therefore, more than one version of a UI plugin can be supported by the cloud services platform UI with a current version of a CSS library of the cloud services platform UI. The cloud services platform UI can provide the CSS library (the current version of the CSS library) to each (e.g., different) UI plugin without causing display errors even if the UI plugins are themselves different versions. Multiple versions of a CSS framework can be supported simultaneously in a browser without spacing side effects from the multiple versions of the CSS framework. Spacing side effects that would otherwise occur can include root element font sizes being different than a current version of a CSS library.

Furthermore, a user can be allowed to select a desired browser font size and the user-selected font size can be allowed to affect a font size presented in an application hosted by the cloud services platform UI. In contrast, some previous approaches may have replaced all rem usages with a pixel equivalent. Such approaches, however, do not take into account user “Accessibility” settings, meaning that when the rem usages are replaced with pixel values, the size of everything remains hard coded, regardless of what browser settings the user prefers or tries to adjust. In other words, the user would not be able to adjust the application's font size for easier viewability. Embodiments of the present disclosure overcome this issue.

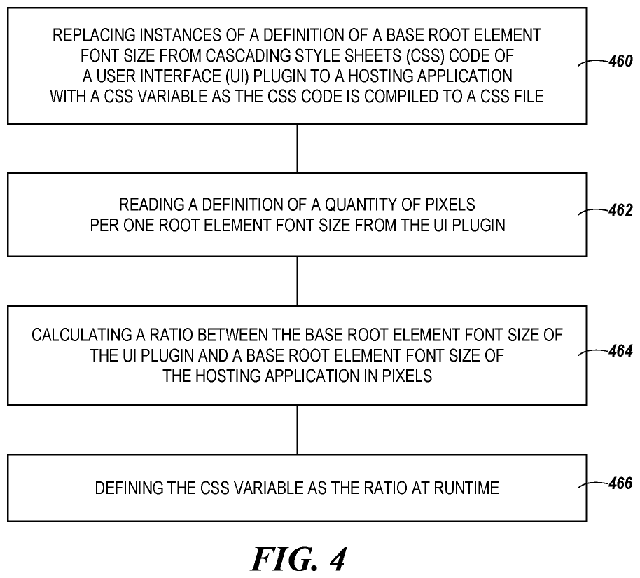

FIG. 4 is a method flow diagram for CSS library isolation. The method may be performed, in some examples, using a system such as described with respect to FIG. 1. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the cloud services platform 114 shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 460, the method can include replacing instances of a definition of a base root element font size from CSS code of a UI plugin to a hosting application with a CSS variable as the CSS code is compiled to a CSS file. One example of the hosting application is a cloud services platform UI. The UI plugin can borrow a CSS library from the cloud services platform UI.

At 462, the method can include reading a definition of a quantity of pixels per one root element font size from the UI plugin. At 464, the method can include calculating a ratio between the base root element font size of the UI plugin and a base root element font size of the hosting application in pixels. The hosting application may include a definition of a quantity of pixels per base root element font size that is different than the definition of the quantity of pixels per base element font size of the UI plugin. The calculation can occur in runtime.

At 466, the method can include defining the CSS variable as the ratio at runtime (e.g., runtime of the hosting application). The method can enable multiple versions of a CSS framework to be supported simultaneously by the hosting application and/or in a browser without spacing side effects from the multiple versions of the CSS framework. Although not specifically illustrated in FIG. 4, the method can be performed for many different UI plugins and many different versions of the UI plugins for one instance of a hosting application and/or one CSS framework, thereby providing backward compatibility for the hosting application and/or CSS framework without causing display issues for different users.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
replacing instances of a definition of a base root element font size from cascading style sheets (CSS) code of a user interface (UI) plugin to a hosting application with a CSS variable as the CSS code is compiled to a CSS file;
reading a definition of a quantity of pixels per one root element font size from the UI plugin;
calculating a ratio between the base root element font size of the UI plugin and a base root element font size of the hosting application in pixels; and
defining the CSS variable as the ratio at runtime.

2. The method of claim 1, wherein the hosting application comprises a cloud services platform UI.

3. The method of claim 2, further comprising borrowing, by the UI plugin, a CSS library from the cloud services platform UI.

4. The method of claim 2, further comprising supporting multiple versions of a CSS framework simultaneously in a browser without spacing side effects from the multiple versions of the CSS framework.

5. The method of claim 4, wherein the runtime comprises runtime of the cloud services platform UI.

6. The method of claim 1, comprising calculating the ratio at runtime.

7. The method of claim 6, wherein the hosting application includes a definition a quantity of pixels per base root element font size that is different than the definition of the quantity of pixels per base element font size of the UI plugin.

8. The method of claim 1, further comprising replacing respective instances of the definition of the base root element font size from respective CSS code of each of a plurality of versions of the UI plugin with a respective CSS variable as the respective CSS code is compiled to respective CSS files;
reading a respective definition of a quantity of pixels per one root element font size from each of the plurality of UI plugins;
calculating a respective ratio between the base root element font size of each of the plurality of UI plugins and the base root element font size of the hosting application in pixels; and
defining the respective CSS variable as the respective ratio at runtime.

9. A non-transitory machine-readable medium having instructions stored thereon which, when executed by a processor, cause the processor to:
replace instances of a first definition of a base root element font size from code of a first version of a user interface (UI) plugin to a hosting application with a first cascading style sheets (CSS) variable as the code of the first version of the UI plugin is compiled;
replace instances of a second definition of a base root element font size from code of a second version of a UI plugin to the hosting application with a second CSS variable as the code of the second version of the UI plugin is compiled;
read a first definition of a first quantity of pixels per one root element font size from the first version of the UI plugin;
read a second definition of a second quantity of pixels per one root element font size from the second version of the UI plugin;
calculate a first ratio between the base root element font size of the first version of the UI plugin and a base root element font size of the hosting application in pixels;
calculate a second ratio between the base root element font size of the second version of the UI plugin and a base root element font size of the hosting application in pixels;
define the first CSS variable as the first ratio at runtime of the hosting application; and
define the second CSS variable as the second ratio at runtime of the hosting application.

10. The medium of claim 9, further comprising instructions to:
replace instances of a third definition of a base root element font size from code of a third version of a UI plugin to the hosting application with a third CSS variable as the code of the third version of the UI plugin is compiled;
read a third definition of a second quantity of pixels per one root element font size from the third version of the UI plugin;
calculate a third ratio between the base root element font size of the third version of the UI plugin and a base root element font size of the hosting application in pixels; and
define the third CSS variable as the second ratio at runtime of the hosting application.

11. The medium of claim 9, wherein the first quantity of pixels per one root element font size is different than the second quantity of pixels per one root element font size.

12. The medium of claim 9, wherein the hosting application comprises a cloud services platform UI.

13. The medium of claim 12, further comprising instructions to present a webpage to a first user of the first version of the UI plugin without spacing side effects; and
present the webpage to a second user of the second version of the UI plugin without spacing side effects.

14. The medium of claim 9, wherein the first version of the UI plugin was developed for a previous version of the hosting application that included a different CSS library than a current version of the hosting application.

15. A system, comprising:
processing and memory resources configured to:
provide a cloud services platform user interface (UI);
support a plurality of versions of a UI plugin hosted by the cloud services platform UI with a current version of a cascading style sheets (CSS) library of the cloud services platform UI;
replace instances of a respective definition of a base root element font size from CSS files of each UI plugin with a respective CSS variable at compile time;
read a respective definition of a respective quantity of pixels per one root element font size from each UI plugin;
calculate a respective ratio between the respective base root element font size of each UI plugin and a base root element font size of the cloud services platform UI in pixels; and
define the respective CSS variable as the respective ratio at runtime.

16. The system of claim 15, wherein the processing and memory resources are further configured to provide the current version of the CSS library from the cloud services platform UI to each UI plugin.

17. The system of claim 15, wherein the processing and memory resources are further configured to support multiple versions of a CSS framework simultaneously in a browser without spacing side effects from the multiple versions of the CSS framework.

18. The system of claim 17, wherein spacing side effects comprise root element font sizes different than the current version of the CSS library.

19. The system of claim 17, wherein the processing and memory resources are further configured to:
allow a user to select a desired browser font size; and
allow the user-selected font size to affect a font size presented in an application hosted by the cloud services platform UI.

20. The system of claim 15, wherein the processing and memory resources are further configured to present a common visualization via each UI plugin regardless of the respective definition of the base root element font size from CSS files of each UI plugin.
